(19) United States
(12) Patent Application Publication
(10) Pub. No.: US 2008/0071791 A1
(43) Pub. Date: Mar. 20, 2008

(54) METAPHOR INTERFACE

(76) Inventors: Adam S. Bates, Rochester, NY (US); Dan Nice, Rochester, NY (US); Brian Dillon, Niskayuna, NY (US); Mike Rotondo, Rochester, NY (US)

Correspondence Address: JAECKLE FLEISCHMANN & MUGEL, LLP, 190 Linden Oaks, ROCHESTER, NY, 14625-2812, US

(21) Appl. No.: 11/533,365

(22) Filed: Sep. 20, 2006

(51) Int. Cl. G06F 17/30

(52) U.S. Cl. 707/10

(57) ABSTRACT

A system for abstracting a social network is described. The system includes a communication network, a database, and a server operatively coupled to the database and the communication network. The system also includes a connection for at least one community member to the communication network. The system further includes a metaphor interface enabling the at least one community member to interact with the database to share news and information.

A method for connecting common groups of people online is described. A metaphor interface is created. Information is published to the metaphor interface. At least one person is invited to access the metaphor interface.

### FIELD

The claimed invention generally relates to social networks, and more specifically to online social networks having a metaphor interface.

### BACKGROUND

With the development and expansion of the internet and online technologies, it has become very popular with younger people to join online social networks. These social networks are often centered around the idea of a “blog”, where different users create web pages containing serial entries about whatever they would like to write about. The more web-savvy users can upload photos for people to view as well. People's blog pages can be open to the public for searching. Often, social networking sites will use information you have provided to search for compatible people who have expressed an interest in a common topic. Such social networking sites often require a certain technical proficiency and familiarity with web lingo which scares people away from using the social networks.

Another concern with many people is not wanting to publish information about themselves online, because they do not like the publicly available nature of the information on the social networking sites, and they do not have the technical skills to create their own custom blog while managing the security of the site.

The blog and existing social networking sites are just a cold and unfamiliar connection point which makes any information on the social networking sites unappealing and uninteresting to many people considering such options.

Therefore it would be advantageous to have a system and method for social networking which would alleviate the concerns and technical hurdles which many people face when considering whether or not to participate in an online community.

### SUMMARY

A system for abstracting a social network is described. The system includes a communication network, a database, and a server operatively coupled to the database and the communication network. The system also includes a connection for at least one community member to the communication network. The system further includes a metaphor interface enabling the at least one community member to interact with the database to share news and information.

A method for connecting common groups of people online is described. A metaphor interface is created. Information is published to the metaphor interface. At least one person is invited to access the metaphor interface.

A data signal for propagation over a propagation medium is also disclosed. The data signal includes a metaphor interface for connecting common groups of people online.

A system for abstracting a blog is described. The system includes a newspaper interface, at least one editor that posts news to a database via the newspaper interface, wherein the news is not serial, and at least one reader that reads news from the database via the newspaper interface.

A system for publishing news briefs is also disclosed. The system includes an online newspaper that is personalized to give a reader the news briefs the reader wants from people the reader would like to hear from within an online community.

### BRIEF DESCRIPTION OF THE DRAWINGS

FIGS. 1-2C schematically illustrate embodiments of a system for abstracting a social network.

FIGS. 3A-6 illustrate embodiments of a metaphor interface.

### DETAILED DESCRIPTION

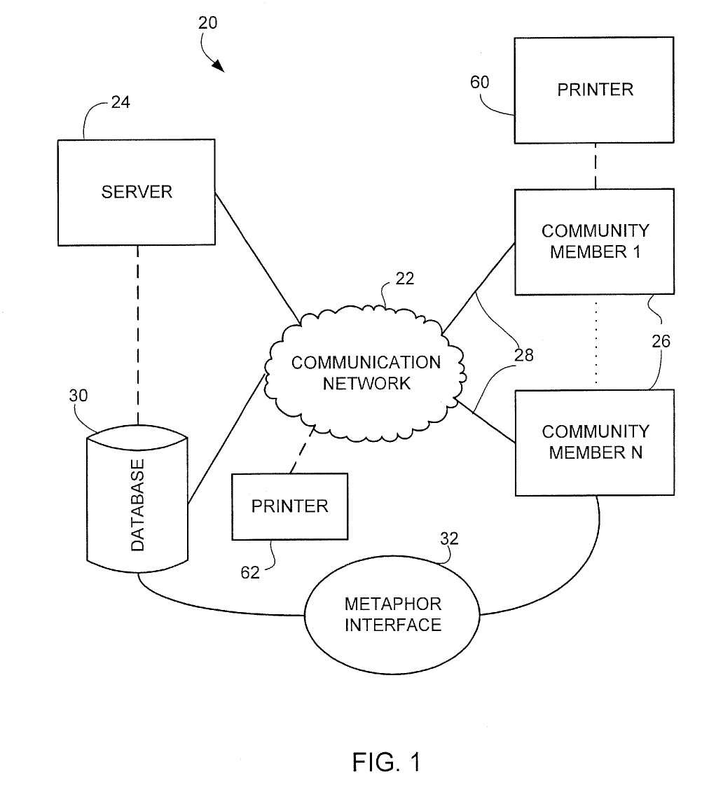

FIG. 1 schematically illustrates an embodiment of a system 20 for abstracting a social network. A communications network 22 is the main coupling point for the system 20. The communication network 22 can be a communications environment incorporating any wired, optical, wireless, or combination thereof method of data communication. Examples of possible networks 26 include a local area network (LAN) such as an intranet, or a wide area network (WAN) such as the internet. In this embodiment, a server 24, and any number of community members 26 are coupled to the network 22. The server 24 and the community members 26 do not need to be connected to the network 22 through the same service provider, but they may share service providers. Different community members do not need to be connected to the network 22 at the same time. Certain communications protocols, such as, for example, TCP/IP, IEEE 802.11, Bluetooth®, IEEE 1394, and/or USB may be used to communicate with and throughout portions or all of the network 22. Various network 22 configurations are known to those skilled in the art, or may be developed by those skilled in the art for the purpose of allowing communication between server 24 and the community members 26. All such network connections and any protocols necessary to effect such communications are considered to be within the scope of this disclosure.

The connection 28 for each community member 26 may be made using a variety of devices, including, but not limited to a computer, a PDA, a smartphone, a laptop, a kiosk, an appliance, a watch, a camera, a camcorder, a digital video recorder, a television, and a watch. Each and any of these devices may be made to connect to the network 22. The manner of connection is not considered limiting to the claimed invention, only that the community members 26 have a device which enables them to connect to the network 22, and therefore to the server 24.

The system 20 also includes a database 30 for storing data that will be part of the social network. Examples of stored data include, for example, users' names, users' passwords for data access, information about the users, contacts authorized by various users as being allowed to view information posted by a given user; information shared by users, and any data structures necessary to implement the features of the system 20 described or referred to in this specification. In the embodiment of FIG. 1, the database 30 is shown coupled to the server 24 by the communication network 22, however, the database 30 could be coupled directly to the server 24 in other embodiments, including being resident on the server 24. In other embodiments, the server 24 could actually be a series of distributed servers.

The system 20 for abstracting a social network also includes a metaphor interface 32 enabling the community members 26 to interact with the database 30 to share news and information. The metaphor interface 32 is a more comfortable interface for the community member 26 to interact with, which helps to hide or abstract the typically non-intuitive web-lingo and actions necessary to access and share information within an online social network. Although one metaphor interface 32 us illustrated in the embodiment of FIG. 1, it should be understood that multiple metaphor interfaces could be used in other embodiments, allowing a user 26 to choose the metaphor interface 32 which is most comfortable for them.

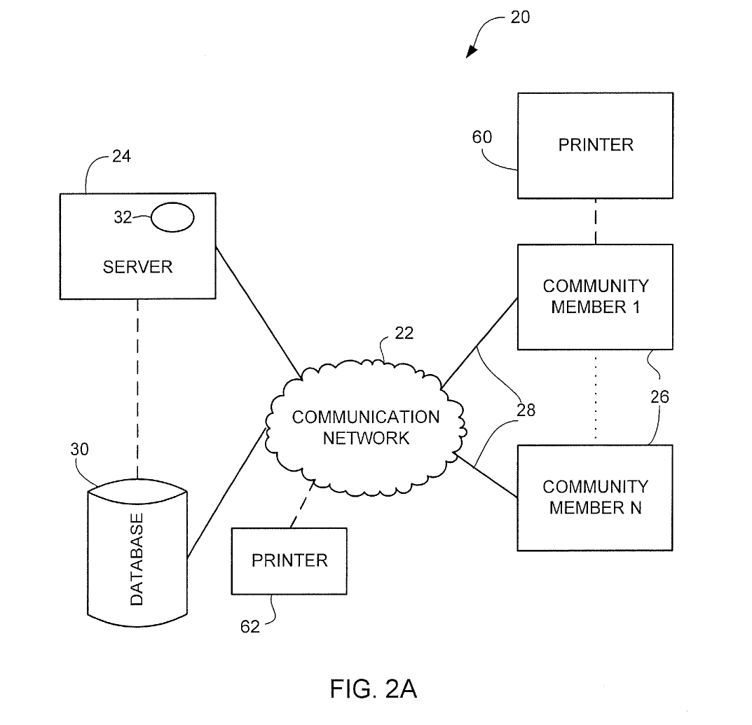

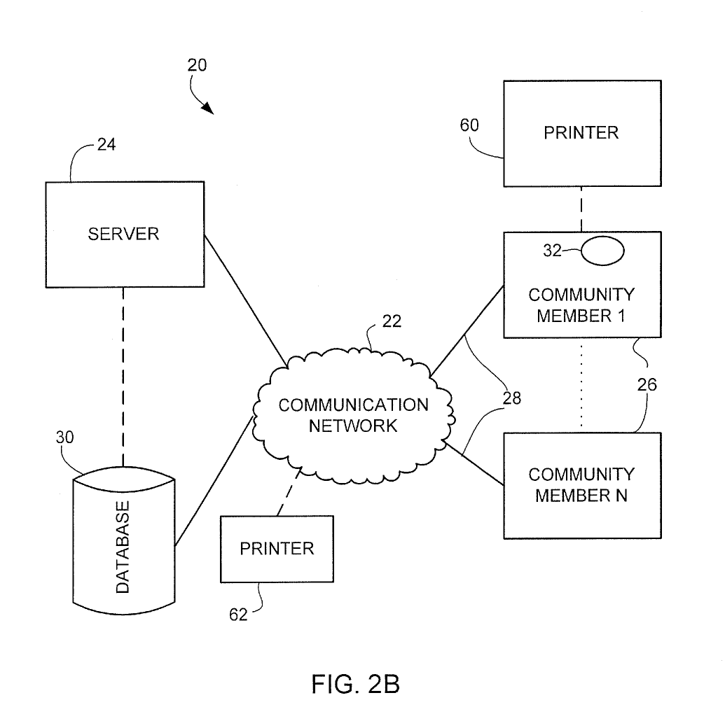

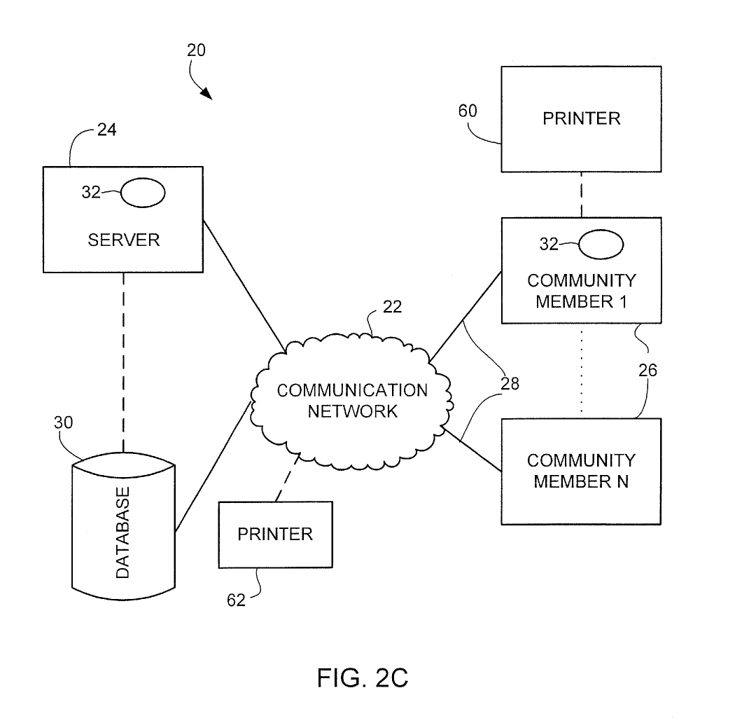

Examples of metaphor interfaces may include, but are not limited to, a newspaper, a magazine, a newspaper section (such as the sports section, the travel section, etc), want ads, tabloids, calendars, newspaper columns, advertisements, comics, newsflashes, family newsletters, corporate newsletters, and campus newsletters. Each of these examples of metaphor interfaces 32 provide a thematic structure or template for the information to be shared and all are much more common and comfortable to an older crowd than is currently using the existing social networks. Via the metaphor interface 32, people can be publishers, authors, or editors, rather than bloggers or web administrators. The metaphor interface 32 may be implemented in software as machine executable instructions which remove the idea of uploading or database management from the user 26 while giving them formatting options for their information which can enhance the enjoyment of participating in an online community with little or no effort on the user's part. The metaphor interface 32 may be installed and run on the server 24 as illustrated in the embodiment of FIG. 2A. Alternatively, the metaphor interface 32 may be installed and run on the connection device used by the community members 26, as illustrated in the embodiment of FIG. 2B. In other embodiments, the metaphor interface 32 may be implemented using machine readable code resident on both the server 24 and the connection devices used by the community members 26.

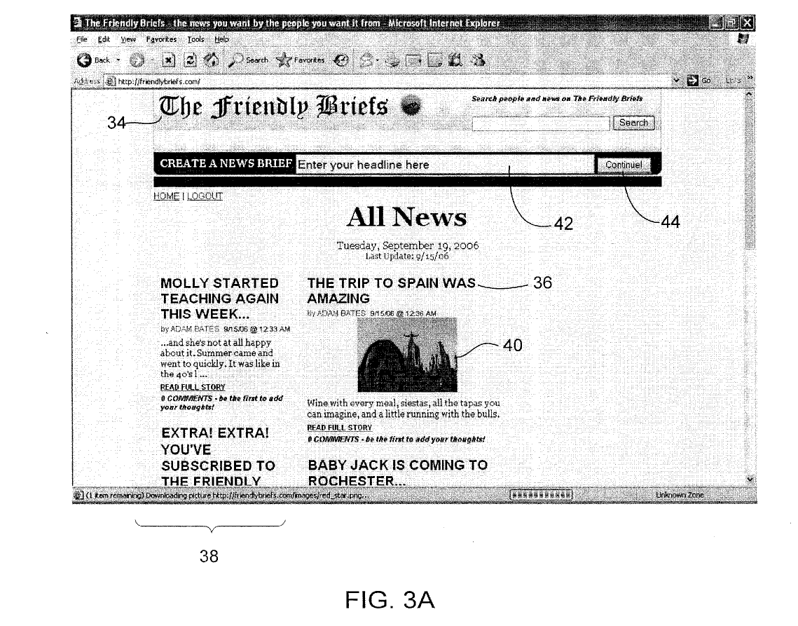

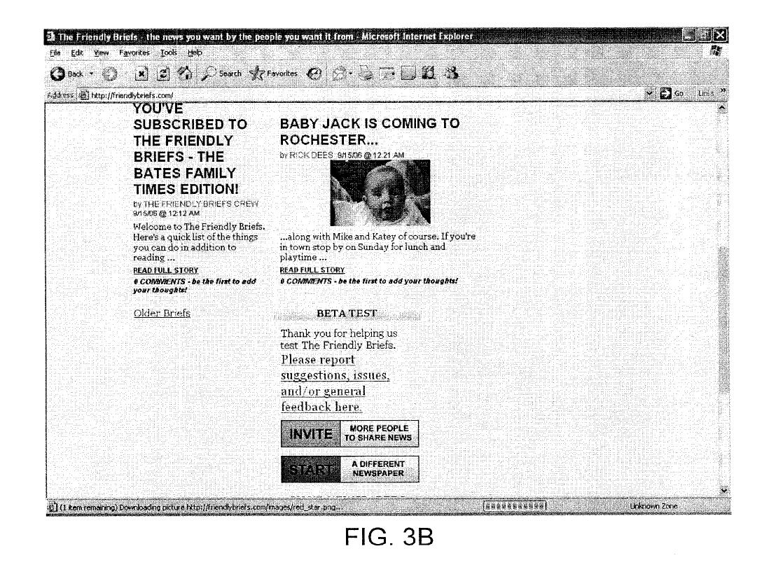

FIG. 3 illustrates how one embodiment of a metaphor interface for use in a social network might be implemented. It should be understood that this is only one embodiment, and other types of metaphor interfaces could be envisioned and implemented, such as those listed above, in other embodiments. In this embodiment, a social network called the ‘Friendly Briefs” 34 allows community members to create their own newspapers. When you log-on to the page, you see all the news from the newspapers which you subscribe to. These newspapers can be ones which you have created and invited others to view, or those which others have invited you to view. The invitation-only format helps to alleviate concerns over the security of the news being published.

The metaphor interface formats the text to look like a newspaper layout in this case, because the metaphor is a newspaper. Titles are made to look like headlines 36 and the news is put in columns 38 with pictures 40 as appropriate. The metaphor interface can have rules set-up to position stories with pictures in a set place, such as in the middle column. FIG. 3B illustrates what the embodiment of FIG. 3A might look like if the member scrolled down the newspage. Other embodiments may have other rules, including ones which are automatic or user definable and selectable. When you have news to share, you can enter a headline 42 and press the continue button 44.

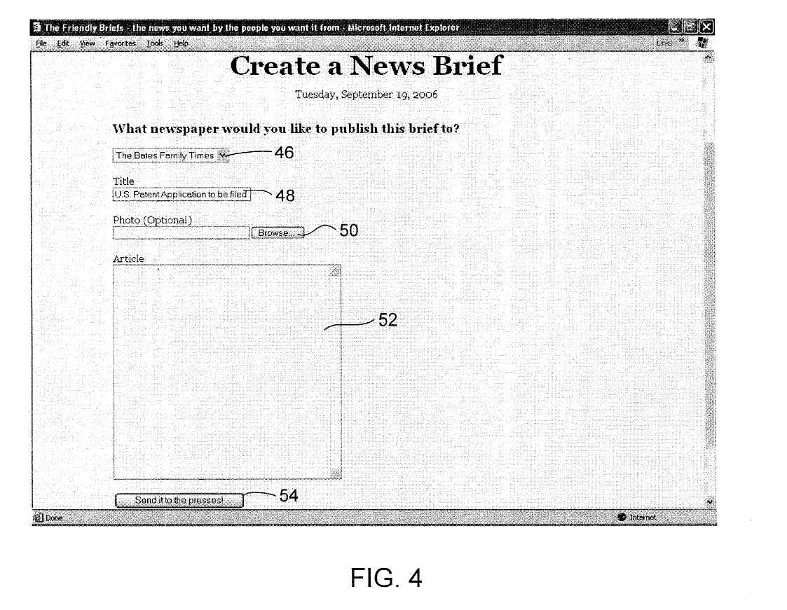

This action might bring the member to the newsbrief creation page illustrated in FIG. 4. The user can select 46 which of their newspapers they want to publish in. They have a chance to modify the title 48 or leave it the same. The user can optionally browse 50 to a photo on their computer. There is a text box 52 within which the news article can be written. Finally, the user can publish the story by clicking the button to send it to the presses 54.

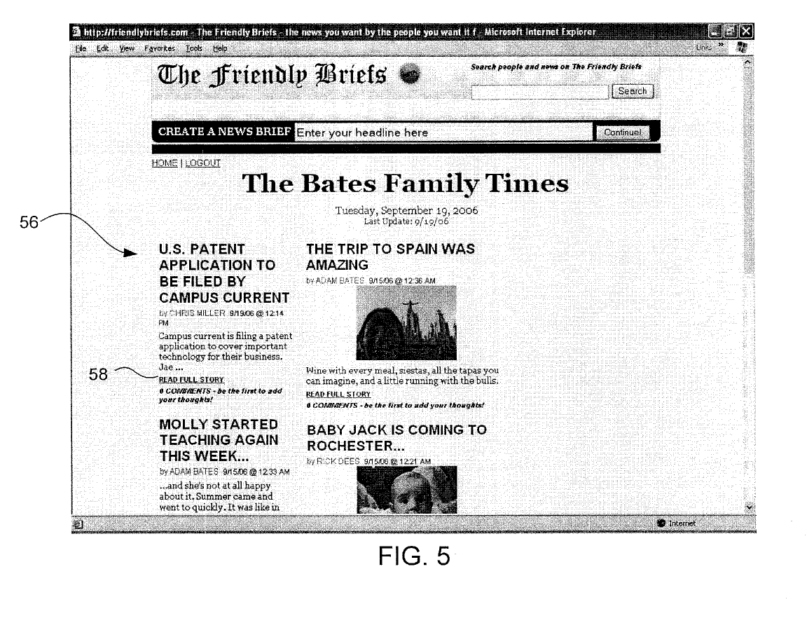

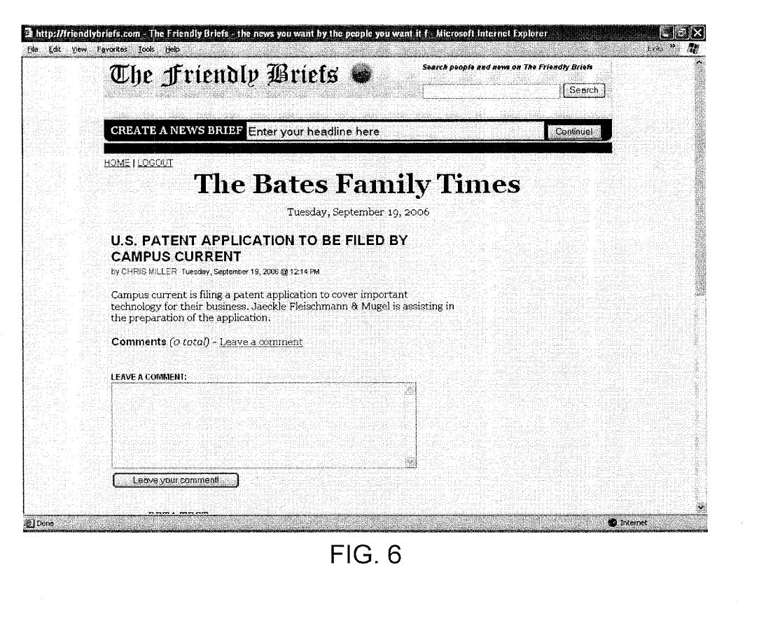

FIG. 5 illustrates a sample news story 56 which was added to the Bates Family Times using the newspaper metaphor interface. If a viewer clicks on the read full story link 58, they can be presented with a page such as the one illustrated in FIG. 6 showing the entire story. Some embodiments may include a feedback feature where readers can type comments on a story for others to see.

The metaphor interface is powerful because it abstracts the technical nature of what is happening to implement an online community for those who are more comfortable with non-technical terms, or for those who prefer a more traditional interface. Having online community news presented in a non-serial layout such as some metaphor interfaces can provide adds visual interest.

In some embodiments, the metaphor interface may allow the publishers to select certain options about the stories they are publishing. For example, the publishing process may include a prompt for how long the published information should remain visible to others before it is deleted. The user could optionally be prompted for the importance of the story, allowing the metaphor interface to assign headline or priority positions to more important stories, and perhaps sideline less important stories. More important stories could also be assigned a longer viewable time before being supplanted by newer stories. More advanced functionality could be enabled for more savvy users, whereby they could choose the exact placement, size, and formatting for their metaphor, but the real power would reside in automating and abstracting such tasks from the user.

Further embodiments of the metaphor interface could provide formatting tools to graphically enhance the posted information. For example, publishers could choose from libraries of clipart to attach with a given story. The metaphor interface could also search the headline or story text for keywords which would cause a matching picture to automatically be inserted with the story. A picture associated with the story author or publisher could be inserted automatically. Newspaper names could be enhanced in various ways, including allowing a graphic title bar, instead of simply a text bar. Some or all of these options could be premium subscription features in certain embodiments.

Other embodiments of a metaphor interface may include a video newscast, where people can publish videos. Further embodiments of a metaphor interface may include an audio broadcast, where people can publish audio recordings. These video and/or audio elements could be embelished with text and/or commentary depending on the desired implementation.

In addition to making online communities more palatable to those outside of the technical web-lingo loop, the metaphor interface can also provide a service which connects those who do not have access to the communication network 22 to the newspapers, etc. which their family and/or friends may be creating.

Referring again to FIG. 1, in some embodiments, there can be a printer 60 locally accessible to a community member 26. The metaphor interface 32 can be written to allow local printing of the metaphor formatted for a particular page size, and including the entire text of the stories, either continuous or split up as is done with newspaper columns, depending on the metaphor being used in the embodiment. The resultant hardcopy can be shared with others who do not have electronic access to the communication network 22.

Alternatively, in other embodiments, there can be a printer 62 coupled to the network 22 remote from the community member 26. The metaphor interface can be written to allow remote printing of the metaphor similarly to the local printer discussed above. With remote printing, however, other options may be possible, since large digital printers and/or presses can be utilized, bringing the capability of large-format printing. Depending on the metaphor interface, this can enable newspaper-like, magazine-like, etc. publications to be created which are even more authentic than a local printer might be able to produce. The remote printer could be coupled with a service which uses regular mail to deliver the hard copy production to any desired recipient.

Such printings, whether local or remote could be automated within the metaphor interface such that regular printouts are sent to desired people on a distribution list, thereby connecting those outside of the technical world to valuable family and friend information.

Further embodiments of the metaphor interface may contain features to create summary publications based on all the stories published within a given period of time. For example, if a family uses a metaphor interface to publish an online newspaper for their friends, at the end of the year, they could choose a summary option from the metaphor interface. The summary option might go through all of the past stories and put together a year-in-review newspaper containing only the stories marked major headline from the last year. All of this could be automated. Such a feature would also be useful to a corporation wanting to publish highlights from their year in business.

Having thus described several embodiments of the claimed invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A system for abstracting a social network, comprising:
a communication network;
a database;
a server operatively coupled to the database and the communication network;
connection for at least one community member to the communication network; and
a metaphor interface enabling the at least one community member to interact with the database to share news and information.

2. The system of claim 1, wherein the metaphor interface is resident on the server.

3. The system of claim 2, wherein the database is directly coupled to the server.

4. The system of claim 2, wherein the database is coupled to the server via the communication network.

5. The system of claim 1, wherein the metaphor interface is resident on a connection device enabling the connection for the at least one community member to the communication network.

6. The system of claim 1, wherein the database is resident on a connection device enabling the connection for the at least one community member to the communication network.

7. The system of claim 1, wherein the server is resident on a connection device enabling the connection for the at least one community member to the communication network.

8. The system of claim 1, wherein the connection for the at least one community member to the communication network is provided by a device selected from the group consisting of: a computer, a PDA, a smartphone, a laptop, a kiosk, an appliance, a watch, a camera, a camcorder, a digital video recorder, a television, and a watch.

9. The system of claim 1, wherein the metaphor interface comprises a newspaper.

10. The system of claim 1, wherein the metaphor interface comprises a magazine.

11. The system of claim 1, wherein the metaphor interface comprises a video news broadcast.

12. The system of claim 1, wherein the metaphor interface comprises an audio broadcast.

13. The system of claim 1, wherein the metaphor interface is selected from a group consisting of newspaper sections, want ads, tabloid, calendar events, newspaper columns, advertisements, comics, newsflashes, family newsletters, corporate newsletters, and campus newsletters.

14. The system of claim 1, further comprising a printer, and wherein the metaphor interface is printable on the printer.

15. The system of claim 14, wherein the printer is remote from the connection for the at least one community member.

16. The system of claim 1, further comprising a plurality of community members who share information with each other via the metaphor interface.

17. The system of claim 16, further comprising an invitation process to ensure an exclusivity for the plurality of members who share information with each other via the metaphor interface.

18. The system of claim 1, wherein the metaphor interface comprises information posting and formatting tools allowing the at least one community member to act as an editor or a publisher.

19. The system of claim 18, wherein the formatting tools allow the at least one community member to decide how long posted information will last.

20. The system of claim 18, wherein the formatting tools allow the at least one community member to decide where posted information on a layout for the metaphor interface will go.

21. The system of claim 18, wherein the formatting tools graphically enhance the posted information.

22. The system of claim 21, wherein the formatting tools graphically enhance the posted information based on content.

23. The system of claim 21, wherein the formatting tools comprise different levels of formatting which comprise a base level and subscription levels.

24. A method for connecting common groups of people online, comprising:
creating a metaphor interface;
publishing information to the metaphor interface;
inviting at least one person to access the metaphor interface.

25. The method of claim 24, wherein the metaphor interface is selected from the group consisting of newspapers, newspaper sections, want ads, tabloid, calendar events, newspaper columns, advertisements, comics, newsflashes, family newsletters, corporate newsletters, and campus newsletters.

26. The method of claim 24, further comprising printing the metaphor interface.

27. A machine readable storage medium containing machine readable instructions for:
connecting common groups of people online using a metaphor interface, wherein the people may be publishers and/or readers of information;
formatting the information in a layout format based on preset rules and input from the publishers.

28. The machine readable storage medium of claim 27, wherein formatting the information further comprises offering editorialization features.

29. The machine readable storage medium of claim 28, wherein the editorialization features comprise:
choosing the placement of information;
choosing how long information will be viewable; and
choosing the viewable size of information.

30. A data signal for propagation over a propagation medium, comprising:
a metaphor interface for connecting common groups of people online.

31. A system for abstracting a blog, comprising:
a newspaper interface;
at least one editor that posts news to a database via the newspaper interface, wherein the news is not serial; and
at least one reader that reads news from the database via the newspaper interface.

32. A system for publishing news briefs, comprising:
an online newspaper that is personalized to give a reader the news briefs the reader wants from people the reader would like to hear from within an online community.
